(19) United States
(12) Patent Application Publication
(10) Pub. No.: US 2016/0218362 A1
(43) Pub. Date: Jul. 28, 2016

(54) Positive Electrode Material for Lithium-Ion Cell

(71) Applicant: MITSUI MINING & SMELTING CO., LTD., Tokyo (JP)

(72) Inventors: Shinya Kagei, Takehara-shi (JP); Kyohei Yamaguchi, Takehara-shi (JP); Yoshimi Hata, Takehara-shi (JP)

(73) Assignee: Mitsui Mining & Smelling Co., Ltd., Tokyo (JP)

(21) Appl. No.: 14/917,283

(22) PCT Filed: Sep. 16, 2014
(86) PCT No.: PCT/JP2014/074405

§ 371 Date: Mar. 8, 2016

(30) Foreign Application Priority Data
Sep. 13, 2013 (JP) 2013-191014

(51) Int. Cl. H01M 4/505; H01M 10/0525

(52) U.S. Cl. CPC H01M 4/505; H01M 10/0525; H01M 2004/028

(57) ABSTRACT

Provided is a positive electrode material for a lithium-ion cell, comprising a lithium metal composite oxide having a layer structure and being represented by the general formula Li₁₊ₓMa_{1-x-y}Mb_{y}O₂ (x=0.10 to 0.33, and y=0 to 0.3; Ma always contains Mn, and contains at least one or more elements selected from Ni and Co, and the Mn content in Ma is 30 to 80% by mass; and Mb is at least one or more elements selected from the group consisting of Al, Mg, Ti, Fe and Nb), wherein the positive electrode material has a primary particle average particle diameter of 1.0 μm or larger, and a tap density of 1.9 g/cm³ or higher.

### TECHNICAL FIELD

The present invention relates to a positive electrode material for a lithium-ion cell, comprising a lithium metal composite oxide having a layer structure, particularly an over-lithiated layered lithium metal composite oxide (referred to also as “over-lithiated layered positive electrode material,” “OLO” or the like).

### BACKGROUND ART

Lithium cells, particularly lithium secondary cells, since they have characteristics of high energy density, long life and the like, are used as power supplies for household appliances such as video cameras, and portable electronic devices such as laptop computers and cellular phones. Recently, the lithium secondary cells have been applied also to large-size cells mounted on electric vehicles (EVs), hybrid electric vehicles (HEVs) and the like.

Lithium secondary cells are secondary cells having a following structure. In the charge time, lithium slips out as ions of a positive electrode and migrates to a negative electrode, and is intercalated therein. On the other hand, in the discharge time, lithium ions reversely return from the negative electrode to the positive electrode. And their high energy density is known to be due to potentials of their positive electrode materials.

As positive electrode active materials of lithium secondary cells, there are known, in addition to lithium manganese oxide (LiMn₂O₄) having a spinel structure, lithium metal composite oxides having a layer structure, such as LiCoO₂, LiNiO₂ and LiMnO₂. For example, LiCoO₂ has a layer structure in which a lithium atom layer and a cobalt atom layer are alternately stacked through an oxygen atom layer. It is large in charge and discharge capacity, and excellent in diffusability of lithium ion intercalation and deintercalation. For that reason, many of lithium secondary cells commercially available at present are lithium metal composite oxides having a layer structure, such as LiCoO₂.

Lithium transition metal oxides having a layer structure, such as LiCoO₂ and LiNiO₂, are represented by the general formula: LiMeO₂ (Me: transition metal). The crystal structure of these lithium metal composite oxides having a layer structure is assigned to a space group R-3m (“-” is usually attached on the upper part of “3”, indicating rotatory inversion. The same applies hereinafter); and their Li ions, Me ions and oxide ions occupy the 3a site, the 3b site and the 6c site, respectively. Then, these lithium metal composite oxides are known to assume a layer structure in which a layer (Li layer) composed of Li ions and a layer (Me layer) composed of Me ions are alternately stacked through an O layer composed of oxide ions.

As the lithium metal composite oxide having such a layer structure, although LiCoO₂ is the mainstream at present, since Co is expensive, there has recently been paid attention to over-lithiated layered lithium metal composite oxides (referred to also as “over-lithiated layered positive electrode material,” “OLO” or the like) in which Li is excessively added and the content of Co is reduced.

“xLi₂MnO₃-(1-x)LiMO₂ solid solution (M: Co, Ni or the like)” known as an over-lithiated layered lithium metal composite oxide is a solid solution of a LiMO₂ structure and a Li₂MnO₃ structure. It is reported that the Li₂MnO₃ has a high capacity but is electrochemically inactive, whereas the LiMO₂ is electrochemically active but has a low theoretical capacity; so, with the aim that by making the both into the solid solution, the electrochemically highly active property of the LiMO₂ is utilized while the high capacity of the Li₂MnO₃ is brought out, the solid solution is fabricated and a high capacity can thereby actually be obtained. It is specifically known that when the solid solution is charged at 4.5 V or higher, although the practical capacity of the LiCoO₂ is 160 mAh/g, the effective capacity of the solid solution is improved up to about 200 to 300 mAh/g.

Seeing technologies conventionally disclosed, with respect to lithium metal composite oxides (LiMₓO₂) having a layer structure, for example, Patent Literature 1 discloses an active substance represented by the formula LiNiₓMn₁₋ₓO₂ (wherein 0.7≦x≦0.95) obtained by adding an alkali solution in a mixed aqueous solution of manganese and nickel to coprecipitate manganese and nickel, adding lithium hydroxide, and calcining the resultant.

Patent Literature 2 discloses a positive electrode active material which is composed of crystal particles of an oxide containing three transition metals and is represented by Li[Liₓ(A_{P}B_{Q}C_{R})₁₋ₓ]O₂ (wherein A, B and C are each a different transition metal element; and −0.1≦x≦0.3, 0.2≦P≦0.4, 0.2≦Q≦0.4, and 0.2≦R≦0.4) wherein the crystal structure of the crystal particles is a layer structure and the arrangement of oxygen atoms constituting the oxide is cubic closest packing.

Patent Literature 3 relates to a powder of a lithium metal composite oxide represented by Li_{z}Ni_{1-w}M_{w}O₂ (wherein M is at least one or more metal elements selected from the group consisting of Co, Al, Mg, Mn, Ti, Fe, Cu, Zn and Ga; and the followings are satisfied: 0<w≦0.25, and 1.0≦z≦1.1), and proposes a positive electrode active material for a nonaqueous electrolyte secondary battery wherein the powder is constituted of primary particles of the powder of the lithium metal composite oxide and secondary particles formed by aggregation of a plurality of the primary particles; the shape of the secondary particles is spherical or ellipsoidal; 95% or more of the secondary particles have a particle diameter of 20 μm or smaller, and the average particle diameter of the secondary particles is 7 to 13 μm; the tap density of the powder is 2.2 g/cm³ or higher; the average volume of pores having an average diameter of 40 nm or smaller in a pore distribution measurement using a nitrogen adsorption method is 0.001 to 0.008 cm³/g; and the average crushing strength of the secondary particles is 15 to 100 MPa.

Patent Literature 4 proposes a lithium metal composite oxide having a layer structure wherein the ratio of the crystallite diameter to the average powder particle diameter (D50) determined by a laser diffraction scattering-type particle size distribution measuring method is made to be 0.05 to 0.20, the powder particle being made, for example, by crushing the oxide to a D50 of 2 μm or smaller by a wet crusher or the like, and thereafter granulating and drying the crushed oxide by using a heat spray dryer or the like, and calcining the resultant oxide.

On the other hand, with respect to the above-mentioned over-lithiated layered lithium metal composite oxide, for example, Patent Literature 5 discloses a lithium metal composite oxide represented by the formula Li₁₊ₓNi_{α}Mn_{β}Co_{γ}O₂ (wherein x is in the range of about 0.05 to about 0.25; α is in the range of about 0.1 to about 0.4; β is in the range of about 0.4 and about 0.65; and γ is in the range of about 0.05 to about 0.3), and the like.

### CITATION LIST

### Patent Literature

### Patent Literature 1: Japanese Patent Laid-Open No. 8-171910

### Patent Literature 2: Japanese Patent Laid-Open No. 2003-17052

### Patent Literature 3: Japanese Patent Laid-Open No. 2007-257985

### Patent Literature 4: Japanese Patent No. 4213768 (WO2008/091028)

### Patent Literature 5: National Publication of International Patent Application No. 2012-511809

### SUMMARY OF INVENTION

### Technical Problem

In the xLi₂MnO₃-(1-x)LiMO₂ solid solution (M: Co, Ni or the like) known as a representative example of over-lithiated layered lithium metal composite oxides (OLOs), the charge and discharge capacity per mass can be improved as described above. On the other hand, the crystal is difficult to grow; therefore, the volumetric energy density as an electrode cannot be enhanced and the solid solution has the problem as a positive electrode material of a cell. Further since the Li₂MnO₃ is electrochemically inactive, the solid solution has also a problem being remarkably poor in the rate capability.

Then, the present invention relates to a positive electrode material for a lithium-ion cell, comprising an over-lithiated layered lithium metal composite oxide, by which the volumetric energy density as an electrode can be enhanced and moreover a good rate capability can be materialized, and is to provide a novel positive electrode material for a lithium-ion cell.

### Solution to Problem

The present invention proposes a positive electrode material for a lithium-ion cell, comprising a lithium metal composite oxide having a layer structure and being represented by the general formula Li₁₊ₓMa_{1-x-y}Mb_{y}O₂ (x=0.10 to 0.33, and y=0 to 0.3; Ma always contains Mn, and contains at least one or more elements selected from Ni and Co, and the Mn content in Ma is 30 to 80% by mass; and Mb is at least one or more elements selected from the group consisting of Al, Mg, Ti, Fe and Nb), wherein the positive electrode material has a primary particle average particle diameter of 1.0 μm or larger and a tap density of 1.9 g/cm³ or higher.

### Advantageous Effects of Invention

By using the positive electrode material for a lithium-ion cell which the present invention proposes, as a positive electrode material for a lithium secondary cell, not only the volumetric energy density as an electrode can effectively be enhanced, but also a good rate capability, particularly a good rate capability in the charge time (referred to also as “charge rate capability”) can be materialized. Therefore, the positive electrode material for a lithium-ion cell which the present invention proposes is especially excellent as a positive electrode active material of, especially, vehicular cells, especially ones mounted on electric vehicles (EVs) and hybrid electric vehicles (HEVs).

### BRIEF DESCRIPTION OF DRAWINGS

FIG. 1 is an XRD pattern of a lithium manganese nickel-containing oxide powder (sample) obtained in Example 1.

FIG. 2 is an XRD pattern of a lithium manganese nickel-containing oxide powder (sample) obtained in Comparative Example 1.

FIG. 3 is an XRD pattern of a lithium manganese nickel-containing oxide powder (sample) obtained in Comparative Example 2.

FIG. 4 is a SEM image of the lithium manganese nickel-containing oxide powder (sample) obtained in Comparative Example 1.

FIG. 5 is a SEM image of the lithium manganese nickel-containing oxide powder (sample) obtained in Example 1.

FIG. 6 is a graph showing charge and discharge curves of cells using the lithium manganese nickel-containing oxide powders (samples) obtained in Example 1 and Comparative Example 1.

FIG. 7 is a graph showing a charge rate capability index of the cells using the lithium manganese nickel-containing oxide powders (samples) obtained in Example 1 and Comparative Example 1.

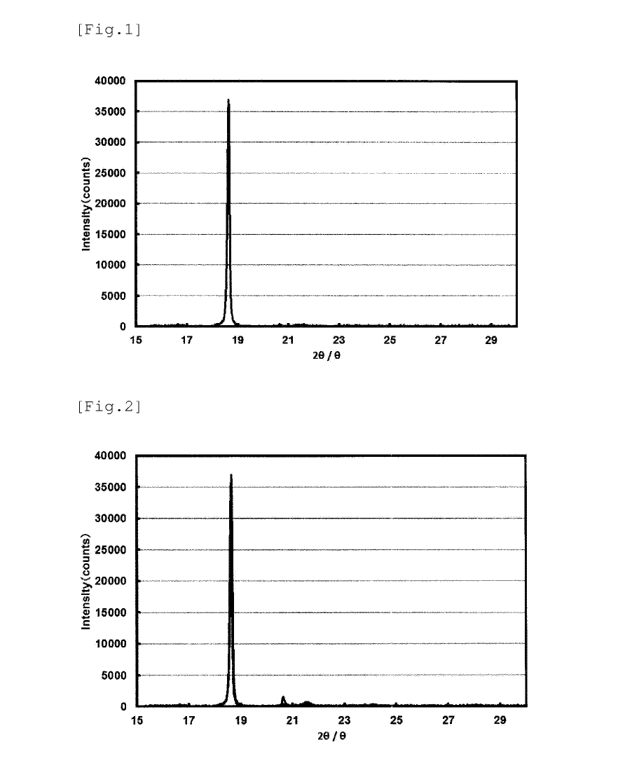

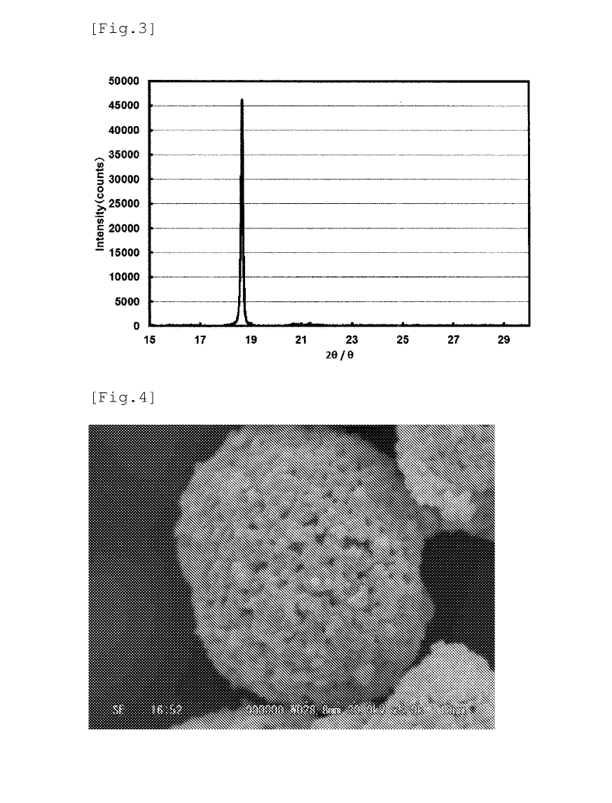

### DESCRIPTION OF EMBODIMENT

Hereinafter, the embodiment according to the present invention will be described. However, the present invention is not limited to the following embodiment.

### <Present Positive Electrode Material>

A positive electrode material for a lithium-ion cell according to the present embodiment (hereinafter, referred to as “present positive electrode material”) is a powder comprising, as its main component, a lithium metal composite oxide having a layer structure and being represented by the general formula Li₁₊ₓMa_{1-x-y}Mb_{y}O₂ (x=0.10 to 0.33, and y=0 to 0.3; Ma always contains Mn, and contains at least one or more elements selected from Ni and Co, and the Mn content in Ma is 30 to 80% by mass; and Mb is at least one or more elements selected from the group consisting of Al, Mg, Ti, Fe and Nb). That is, the positive electrode material is a powder comprising, as its main component, a lithium metal composite oxide having a layer structure in which a lithium atom layer and a transition metal atom layer are alternately stacked through an oxygen atom layer.

Here, “comprising as its main component,” unless otherwise described, implies that other components may be contained unless inhibiting the function of the main component. The content proportion of the main component includes the cases of accounting for at least 50% by mass or more of the present positive electrode material, especially 70% by mass or more, particularly 90% by mass or more, and particularly 95% by mass or more (including 100%).

The present positive electrode material is allowed to contain, as impurities, SO₄ as long as being 1.0% by weight or less and other elements as long as being each 0.5% by weight or less. This is conceivably because the amounts in such degrees scarcely affect the characteristics of the present positive electrode material.

“x” in the above general formula is 0.10 to 0.33, particularly 0.11 or more and 0.32 or less, and more preferably 0.12 or more and 0.31 or less.

Further “y” in the above general formula is 0 to 0.30, particularly 0.005 or more and 0.295 or less, and more preferably 0.01 or more and 0.29 or less.

“Ma” in the above general formula always contains Mn, and contains at least one or more elements selected from Ni and Co, and the Mn content in Ma accounts for 30 to 80% by mass, particularly 31% by mass or more and 79% by mass or less, and preferably 32% by mass or more and 78% by mass or less.

On the other hand, “Mb” suffices if being at least one or more elements selected from the group consisting of Al, Mg, Ti, Fe and Nb.

Here, in the above general formula, the atomic ratio of the amount of oxygen is described as “2” for convenience, but may be more or less unfixed.

### <Average Particle Diameter of the Primary Particle>

The average particle diameter of the primary particle of the present positive electrode material is preferably 1.0 μm or larger, particularly 1.1 μm or larger and 5.0 μm or smaller, and especially preferably 1.2 μm or larger and 4.9 μm or smaller.

By making the average particle diameter of the primary particle of the present positive electrode material to be 1.0 μm or larger, the rate capability, especially the charge rate capability can effectively be enhanced.

The average particle diameter of the primary particle can be determined by using a scanning electron microscope, randomly selecting a plurality of, for example, 10 particles from an acquired microscope photograph, measuring minor diameters of the primary particles, converting the measured lengths on the reduced scale, and determining an average value as the primary particle average particle diameter.

The regulation of the average particle diameter of the primary particle in the above range may be made following process. If in a first step, a lithium metal composite oxide assuming a layer structure composed of, for example, LiMO₂ is produced, and thereafter, a Li raw material is added, and the resultant is again calcined to thereby promote the crystal growth; and the compositional ratios of transition metals (compositional ratios such as Mn:Co:Ni ratio and Li:Mn ratio), the raw material particle sizes, the calcining condition and the like are regulated. For example, by raising the calcining temperature, the average particle diameter of the primary particle can be made large.

### <Tap Density>

The tap density (referred to also as “T.D.”) of the present positive electrode material is 1.9 g/cm³ or higher, particularly 2.0 g/cm³ or higher and 4.4 g/cm³ or lower, and preferably 2.1 g/cm³ or higher and 4.3 g/cm³ or lower. When the tap density is 1.9 g/cm³ or higher, the volumetric energy density as an electrode can effectively be enhanced.

The tap density can be determined, for example, by using a shaking specific gravity meter, putting a sample in a glass measuring cylinder, tapping the measuring cylinder in a predetermined stroke for predetermined times, and measuring a powder packing density.

Such a tap density may be provided, for example, if a solid solution positive electrode is not directly produced but, in a first step, a lithium metal composite oxide assuming a layer structure composed of, for example, LiMO₂ is produced, and thereafter, a Li raw material is added, and the resultant is again calcined. If such a method is followed, the crystal growth can be promoted and not only the powder density can be enhanced, but also the tap density can be enhanced due to the powder characteristic of the lithium metal composite oxide assuming a layer structure produced in the first step. However, the tap density raising method is not limited to such a method.

### <Crystallite Size>

The crystallite size of the present positive electrode material, that is, the crystallite size determined by a measuring method (which will be described in detail in the Example paragraph) using a Rietveld method is preferably 50 nm or larger, particularly 50 nm or larger and 300 nm or smaller, and preferably 51 nm or larger and 290 nm or smaller.

Here, the “crystallite” means a largest aggregation which can be regarded as a single crystal, and can be determined by an XRD measurement and the Rietveld analysis.

A particle of a smallest unit constituted of a plurality of crystallites and surrounded by a grain boundary when being observed by SEM (for example, a magnification of 3,000 times) is referred to as a “primary particle” in the present invention. Therefore, the primary particle contains single crystals and polycrystals.

From such a viewpoint, when the crystallite size of the present positive electrode material is 50 nm or larger, the primary particle can be made larger and the volumetric energy density as an electrode can be enhanced much more.

The regulation of the crystallite size in the above range may be made if in a first step, a lithium metal composite oxide assuming a layer structure composed of, for example, LiMO₂ is produced, and thereafter, a Li raw material is added, and the resultant is again calcined to thereby promote the crystal growth; and the compositional ratios of transition metals (compositional ratios such as Mn:Co:Ni ratio and Li:Mn ratio), the raw material particle sizes, the calcining condition and the like are regulated. For example, by raising the calcining temperature, the crystallite size can be made large.

Here in the present invention, the “crystallite” means a largest aggregation which can be regarded as a single crystal, and can be determined by an XRD measurement and the Rietveld analysis.

A particle of a smallest unit constituted of a plurality of crystallites and surrounded by a grain boundary when being observed by SEM (for example, a magnification of 1,000 to 5,000 times) is referred to as a “primary particle” in the present invention. Therefore, the primary particle contains single crystals and polycrystals.

### <XRD>

In a diffraction pattern of the crystal structure X-ray diffraction (XRD) of the present positive electrode material, the intensity of the main peak in the range of 2θ=20 to 22° to that of the main peak in the range of 2θ=16 to 20° is preferably lower than 4.0%, particularly lower than 3.3%, more particularly lower than 3.0%, and more preferably lower than 2.6%.

Here, the main peak in the range of 2θ=20 to 22° refers to a maximum-intensity peak among peaks present in the range of 2θ=20 to 22°; and the main peak in the range of 2θ=16 to 20° refers to a maximum-intensity peak among peaks present in the range of 2θ=16 to 20°.

In the present positive electrode material, since it is presumed that the main peak in the range of 2θ=20 to 22° is caused by the Li₂MnO₃ structure, that the intensity of such a peak is lower than 4.0% to that of the main peak in the range of 2θ=16 to 20°, that is, to that of the peak caused by the layer structure presumably implies that the present positive electrode material has a single phase structure or a structure near it in which there is almost no Li₂MnO₃ structure.

Examples of methods for producing the present positive electrode material having such characteristics include a method in which a solid solution positive electrode is not directly produced, in a first step, a lithium metal composite oxide assuming a layer structure composed of, for example, LiMO₂ is produced and thereafter, a Li raw material is added, and the resultant is again calcined. However, the production methods are not limited to such a method.

### <D50>

The average particle diameter (D50) of the present positive electrode material as measured by a laser diffraction scattering-type particle size distribution measuring method is preferably 1 μm to 60 μm, particularly 2 μm or larger and 59 μm or smaller, and especially preferably 3 μm or larger and 58 μm or smaller.

The present positive electrode material, when having a D50 of 1 μm to 60 μm, is satisfactory from the viewpoint of electrode fabrication.

The regulation of the D50 of the present positive electrode material in the above range is preferably carried out by regulation of D50 of starting materials, regulation of the calcining temperature and the calcining time, and regulation of D50 by crushing after the calcination. However, regulating methods are not limited to these methods.

Further a particle made by aggregation of a plurality of the primary particles with parts of their outer peripheries (grain boundaries) being shared, with the particle being isolated from other particles, is referred to as a “secondary particle” or an “aggregated particle” in the present invention.

In this connection, the laser diffraction scattering-type particle size distribution measuring method is a measuring method of calculating a particle diameter by capturing an aggregated powder particle as one particle (aggregated particle); and the average particle diameter (D50) means a 50% volume-cumulative particle diameter, that is, a diameter at a cumulation of 50% from the finer side in a cumulative percentage representation of particle diameter measurement values in terms of volume in a chart of a particle size distribution in terms of volume.

### <Specific Surface Area (SSA)>

The specific surface area (SSA) of the present positive electrode material is preferably 0.1 to 3.0 m²/g, particularly 0.2 m²/g or larger and 2.9 m²/g or smaller, and especially preferably 0.3 m²/g or larger and 2.8 m²/g or smaller.

The present positive electrode material, when having a specific surface area (SSA) of 0.1 to 3.0 m²/g, is preferable from the viewpoint of ease of electrode fabrication and good cell characteristics.

The regulation of the specific surface area (SSA) of the present positive electrode material in the above range may be carried out by regulation of the calcining condition (temperature, time, atmosphere and the like), the crushing power (rotation frequency of a crushing machine, and the like) after the calcination, and the like. However, the regulation methods are not limited to this method.

### <Production Method>

Then, a production method of the present positive electrode material will be described.

The present positive electrode material can be obtained by weighing and mixing raw materials, for example, a lithium salt compound, a manganese salt compound, a nickel salt compound and a cobalt salt compound, crushing the mixture by a wet crusher or the like, thereafter granulating and calcining the crushed mixture, as required, subjecting the resultant to a heat treatment, crushing the resultant under a preferable condition, and further as required, classifying the resultant, to thereby fabricate a lithium metal composite oxide assuming a layer structure composed of LiMO₂ (M is for example, Co and Ni) and the like. And thereafter, adding a lithium salt compound to the lithium metal composite oxide, and as in the above, again mixing and calcining the resultant, and as required, subjecting the resultant to a heat treatment, crushing the resultant under a preferable condition. And further as required, classifying the resultant.

A positive electrode having a high electrode density can be fabricated because not only the crystal growth can be promoted by not directly producing a solid solution positive electrode but, in a first step, producing a lithium metal composite oxide assuming a layer structure composed of, for example, LiMO₂, and in the subsequent step, adding a Li raw material and again calcining the resultant, in such a manner, but also the powder density can be enhanced due to the powder characteristic of the lithium metal composite oxide assuming a layer structure produced in the first step.

Examples of lithium raw materials include lithium hydroxide (LiOH), lithium carbonate (Li₂CO₃), lithium nitrate (LiNO₃), LiOH.H₂O, lithium oxide (Li₂O), and besides, lithium fatty acid lithium and lithium halides. Among these, hydroxide salts, carbonate salts and nitrate salts of lithium are preferable.

Manganese raw materials are not especially limited. For example, manganese carbonate, manganese nitrate, manganese chloride and manganese dioxide can be used, and among these, manganese carbonate and manganese dioxide are preferable. Among these, electrolytic manganese dioxide obtained by an electrolysis method is especially preferable.

Nickel raw materials are not especially limited. For example, nickel carbonate, nickel nitrate, nickel chloride, nickel oxyhydroxide, nickel hydroxide and nickel oxide can be used, and among these, nickel carbonate, nickel hydroxide and nickel oxide are preferable.

Cobalt raw materials are not especially limited. For example, basic cobalt carbonate, cobalt nitrate, cobalt chloride, cobalt oxyhydroxide, cobalt hydroxide and cobalt oxide can be used, and among these, basic cobalt carbonate, cobalt hydroxide, cobalt oxide and cobalt oxyhydroxide are preferable.

Raw materials for “Mb” in the above general formula are not especially limited. Preferable are, for example, oxides, hydroxides, carbonates and the like of elements (Al, Mg, Ti, Fe, Nb and the like).

Mixing of raw materials is carried out preferably by adding a liquid medium such as water and a dispersant to the raw materials and wet mixing the resultant to thereby make a slurry. Then, in the case of employing a spray drying method described later, the obtained slurry is preferably crushed by a wet crusher. However, the crushing may be dry crushing.

A granulation method may be of a wet type or a dry type as long as the raw materials crushed in the previous step are not separated and dispersed in granulated particles, and may be an extruding granulation method, a tumbling granulation method, a fluidized granulation method, a mixing granulation method, a spray drying granulation method, a pressing granulation method, or a flake granulation method using a roll or the like. However, in the case of the wet granulation, sufficient drying before the calcination is needed. The drying may be carried out by a well-known drying method such as a spray heat drying method, a hot air drying method, a vacuum drying method, or a freeze drying method, and among these, a spray heat drying method is preferable. The spray heat drying method is carried out preferably by using a heat spray dryer (spray drier) (in the present description, referred to as “spray drying method”).

Here, a coprecipitated powder to be supplied to calcination may be fabricated, for example, by a so-called coprecipitation method (in the present description, referred to as “coprecipitation method”). The coprecipitation method can provide a coprecipitated powder by dissolving raw materials in a solution, and thereafter regulating conditions including pH to thereby precipitate the coprecipitated powder.

The calcination is carried out in a calcining furnace preferably in an air atmosphere, an oxygen gas atmosphere, an atmosphere whose oxygen partial pressure is regulated, a carbon dioxide gas atmosphere, or another atmosphere, by holding its temperature at a temperature of higher than 800° C. and lower than 1,500° C. (the temperature is that in the case where a material to be calcined in the calcining furnace is brought into contact with a thermocouple), preferably 810° C. or higher and 1,300° C. or lower, more preferably 820° C. or higher and 1,100° C. or lower, for 0.5 hours to 300 hours. At this time, it is preferable to select the calcination condition where transition metals dissolve in the atomic level as a solid solution and exhibit a single phase.

In this connection, the calcination condition where transition metals dissolve in the atomic level as a solid solution and exhibit a single phase includes a method in which a layer-structure compound is once produced by calcination, and thereafter, a Li raw material is added, and the resultant is again calcined.

The kind of the calcining furnace is not especially limited. The calcination can be carried out, for example, by using a rotary kiln, a stationary furnace or another calcining furnace.

It is preferable in the case where the regulation of the crystal structure is needed that the heat treatment after the calcination is carried out, and the heat treatment may be carried out under the condition of an oxidative atmosphere such as an air atmosphere, an oxygen gas atmosphere, and an atmosphere whose oxygen partial pressure is regulated.

The cracking after the calcination or the heat treatment may be carried out, as required, by using a high-speed rotary crusher or the like as described before.

When the crushing is carried out by a high-speed rotary crusher, aggregation of particles and weakly sintered portions can be crushed, and moreover, strains can be prevented from being generated in particles. It is not, however, that cracking mean is limited to a high-speed rotary crusher.

One example of the high-speed rotary crusher includes a pin mill. The pin mill is known as a disk rotary crusher, which is a crushing machine of such a system that rotation of a rotary disk with pins causes the interior pressure to be sucked a powder in from the raw material feed port. Hence, whereas microparticles are easily carried on the air stream because of their light weight, and pass through the clearance in the pin mill, coarse particles are securely crushed. Hence, use of a pin mill enables the aggregation of particles and weakly sintered portions to be securely cracked and also can prevent strains from being generated in particles.

The rotation frequency of the high-speed rotary crusher is made to be 4,000 rpm or higher, especially 5,000 to 12,000 rpm, and more preferably 7,000 to 10,000 rpm.

The classification after the calcination, because of having a technical significance of regulation of the particle size distribution of an aggregated powder and removal of foreign matter, is preferably carried out by selecting a sieve having a preferable sieve opening.

Then, a lithium salt compound is added to the thus obtained lithium metal composite oxide assuming a structure, again pre-mixed and calcined as in the above, and as required, subjected to a heat treatment, crushed under a preferable condition, and further as required, classified, to thereby obtain the present positive electrode material.

At this time, although the mixing, the calcination, the heat treatment, the cracking, the classification and the like may be carried out as described above, the conditions for these procedures do not need to be coincident with the conditions for the LiMO₂ powder.

### <Characteristics and Applications>

The present positive electrode material is, as required, cracked and classified, and thereafter as required, mixed with other positive electrode materials, and can effectively be utilized as a positive electrode active material of a lithium cell.

A positive electrode mixture can be produced, for example, by mixing the present positive electrode material, a conductive material composed of carbon black and the like, and a binder composed of a Teflon® binder. Then, by using such a positive electrode mixture for a positive electrode, using, for example, lithium or a material capable of intercalating and deintercalating lithium, such as carbon, for a negative electrode, and using, for a nonaqueous electrolyte, a solution in which a lithium salt such as lithium hexafluorophosphate (LiPF₆) is dissolved in a mixed solvent of ethylene carbonate-dimethyl carbonate or the like, a lithium secondary cell can be constituted. However, cell constitutions are not limited to such a constitution.

Lithium cells which have the present positive electrode material as their positive electrode active material are especially excellent for an application to a positive electrode active substance of lithium cells used as motor driving power supplies mounted especially on electric vehicles (EVs) and hybrid electric vehicles (HEVs).

Here, the “hybrid vehicles” are vehicles which concurrently use two power sources of an electric motor and an internal combustion engine, and include plug-in hybrid vehicles.

Further the “lithium cells” means including every cell containing lithium or lithium ions therein, such as lithium primary cells, lithium secondary cells, lithium ion secondary cells and lithium polymer cells.

### Explanation of Terms

In the present description, in the case of being expressed as “X to Y” (X and Y are arbitrary numbers), unless otherwise specified, the expression includes a meaning of “X or more and Y or less,” and also a meaning of “preferably more than X” and “preferably less than Y.”

Further in the case of being expressed as “X or more” (X is an arbitrary number” or “Y or less” (Y is an arbitrary number), the expression includes an intention to the effect of “preferably more than X” or “preferably less than Y.”

### EXAMPLES

Then, based on Examples and Comparative Examples, the present invention will be described further. The present invention, however, is not limited to the following Examples.

### Comparative Example 1

Lithium carbonate, electrolytic manganese dioxide and nickel hydroxide were weighed so that the composition became Li_{1.15}Ni_{0.575}Mn_{0.275}O₂; and water was added thereto, and mixed and stirred to thereby prepare a slurry having a solid content concentration of 10% by weight.

A polycarboxylic acid ammonium salt (manufactured by San Nopco Ltd., SN Dispersant 5468) of 6% by weight of the slurry solid content as a dispersant was added to the obtained slurry (500 g as a raw material powder), and crushed by a wet crusher at 1,200 rpm for 20 min into an average particle diameter (D50) of 0.5 μm or smaller to thereby obtain a crushed slurry.

The obtained crushed slurry was granulated and dried by using a heat spray dryer (manufactured by Ohkawara Kakohki Co., Ltd., Spray Dryer “i-8”). At this time, the spraying used a rotary disk, and the granulation and drying was carried out at a rotation frequency of 24,000 rpm, at an amount of slurry to be fed of 12 kg/hr and by regulating the temperature so that the temperature of the outlet port of the drying tower became 100° C. The average particle diameter (D50) of the granulated powder was 15 μm.

The obtained granulated powder was heated by using a stationary electric furnace at a temperature-rise rate of 1.3° C./min up to 950° C., and maintained at 950° C. for 20 hours. Thereafter, the powder was cooled at a temperature-fall rate of 1.3° C./min down to 700° C., maintained at 700° C. for 10 hours, and thereafter cooled at a temperature-fall rate of 1.3° C./min down to room temperature. The obtained powder was crushed, and by again using the stationary electric furnace, heated at a temperature-rise rate of 1.3° C./min up to 950° C. in the air, maintained at 950° C. for 20 hours, and thereafter cooled at a temperature-fall rate of 1.3° C./min down to 700° C., maintained at 700° C. for 10 hours, and thereafter cooled at a temperature-fall rate of 1.5° C./min down to room temperature. Thereafter, the obtained powder was crushed and classified with a sieve having a sieve opening of 53 μm; and the undersize powder was recovered to thereby obtain a lithium manganese nickel-containing oxide powder (sample).

As a result of a chemical analysis of the obtained lithium manganese nickel-containing oxide powder (sample), it was confirmed that the sample powder was Li_{1.17}Ni_{0.56}Mn_{0.27}O₂.

### Comparative Example 2

Lithium carbonate, electrolytic manganese dioxide and nickel hydroxide were weighed so that the composition became Li_{1.2}Ni_{0.4}Mn_{0.4}O₂; and water was added thereto, and mixed and stirred to thereby prepare a slurry having a solid content concentration of 10% by weight.

A polycarboxylic acid ammonium salt (manufactured by San Nopco Ltd., SN Dispersant 5468) of 6% by weight of the slurry solid content as a dispersant was added to the obtained slurry (500 g as a raw material powder), and crushed by a wet crusher at 1,200 rpm for 20 min into an average particle diameter (D50) of 0.5 μm or smaller to thereby obtain a crushed slurry.

The obtained crushed slurry was granulated and dried by using a heat spray dryer (manufactured by Ohkawara Kakohki Co., Ltd., Spray Dryer “i-8”). At this time, the spraying used a rotary disk, and the granulation and drying was carried out at a rotation frequency of 24,000 rpm, at an amount of slurry to be fed of 12 kg/hr and by regulating the temperature so that the temperature of the outlet port of the drying tower became 100° C. The average particle diameter (D50) of the granulated powder was 15 μm.

The obtained granulated powder was heated by using a stationary electric furnace at a temperature-rise rate of 1.3° C./min up to 950° C., and maintained at 950° C. for 20 hours. Thereafter, the powder was cooled at a temperature-fall rate of 1.3° C./min down to 700° C., maintained at 700° C. for 10 hours, and thereafter cooled at a temperature-fall rate of 1.3° C./min down to room temperature. Thereafter, the obtained powder was crushed, and classified with a sieve having a sieve opening of 53 μm; and the undersize powder was recovered to thereby obtain a lithium manganese nickel-containing oxide powder (sample).

As a result of a chemical analysis of the obtained lithium manganese nickel-containing oxide powder (sample), was confirmed that the sample powder was Li_{1.21}Ni_{0.40}Mn_{0.39}O₂.

### Example 1

Lithium carbonate, electrolytic manganese dioxide and nickel hydroxide were weighed so that the composition became Li_{1.06}Ni_{0.47}Mn_{0.47}O₂; and water was added thereto, and mixed and stirred to thereby prepare a slurry having a solid content concentration of 10% by weight.

A polycarboxylic acid ammonium salt (manufactured by San Nopco Ltd., SN Dispersant 5468) of 6% by weight of the slurry solid content as a dispersant was added to the obtained slurry (500 g as a raw material powder), and crushed by a wet crusher at 1,200 rpm for 20 min into an average particle diameter (D50) of 0.5 μm or smaller to thereby obtain a crushed slurry.

The obtained crushed slurry was granulated and dried by using a heat spray dryer (manufactured by Ohkawara Kakohki Co., Ltd., Spray Dryer “i-8”). At this time, the spraying used a rotary disk, and the granulation and drying was carried out at a rotation frequency of 24,000 rpm, at an amount of slurry to be fed of 12 kg/hr and by regulating the temperature so that the temperature of the outlet port of the drying tower became 100° C. The average particle diameter (D50) of the granulated powder was 15 μm.

The obtained granulated powder was heated by using a stationary electric furnace at a temperature-rise rate of 1.5° C./min up to 700° C. in the air, and maintained at 700° C. for 20 hours. Thereafter, the powder was cooled at a temperature-fall rate of 1.5° C./min down to room temperature. Then, the powder, by again using the stationary electric furnace, was heated at a temperature-rise rate of 1.5° C./min up to 1,000° C. in the air, maintained at 1,000° C. for 30 hours (this heat keeping treatment is referred to as “regular calcination 1”), and thereafter cooled at a temperature-fall rate of 1.5° C./min down to room temperature. The calcined powder thus obtained was crushed and classified with a sieve having a sieve opening of 53 μm; and the undersize powder was recovered.

As a result of a chemical analysis of the recovered powder, it was confirmed that the recovered powder was Li_{1.06}Ni_{0.47}Mn_{0.47}O₂.

Then, lithium carbonate was added to the recovered undersize powder so as to make a target composition Li_{1.13}Mn_{0.45}Ni_{0.42}O₂, and mixed by using a ball mill for 1 hour. The obtained mixed powder, by using a stationary electric furnace, was heated at a temperature-rise rate of 1.3° C./min up to 1,050° C. in the air, maintained at 1,050° C. for 20 hours (this heat keeping treatment is referred to as “regular calcination 2”), and thereafter cooled at a temperature-fall rate of 1.3° C./min down to room temperature. The calcined powder thus obtained was crushed and classified with a sieve having a sieve opening of 53 μm; and the undersize powder was recovered to thereby obtain a lithium manganese nickel-containing oxide powder (sample).

As a result of a chemical analysis of the obtained lithium manganese nickel-containing oxide powder (sample), it was confirmed that the sample powder was Li_{1.13}Ni_{0.45}Mn_{0.42}O₂.

### Example 2

Lithium carbonate, electrolytic manganese dioxide and nickel hydroxide were weighed so that the composition became Li_{1.06}Mn_{0.56}Ni_{0.38}O₂, and mixed; and the heat keeping temperature of the regular calcination 1 was altered to 800° C., and an undersize powder was recovered as in Example 1. As a result of a chemical analysis of the recovered powder, it was confirmed that the recovered powder was Li_{1.06}Mn_{0.56}Ni_{0.38}O₂.

Then, lithium carbonate was added to the recovered undersize powder so as to make a target composition Li_{1.16}Mn_{0.50}Ni_{0.34}O₂; and a lithium manganese nickel-containing oxide powder (sample) was obtained as in Example 1, except for altering the heat keeping temperature of the regular calcination 2 to 1,000° C.

As a result of a chemical analysis of the obtained lithium manganese nickel-containing oxide powder (sample), it was confirmed that the sample powder was Li_{1.16}Mn_{0.50}Ni_{0.34}O₂.

### Example 3

Lithium carbonate, electrolytic manganese dioxide, nickel hydroxide and aluminum hydroxide were weighed so that the composition became Li_{1.06}Mn_{0.37}Ni_{0.14}Al_{0.10}Ni_{0.33}O₂, and mixed; and the heat keeping temperature of the regular calcination 1 was altered to 1,000° C., and an undersize powder was recovered as in Example 1. As a result of a chemical analysis of the recovered powder, it was confirmed that the recovered powder was Li_{1.06}Mn_{0.37}Ni_{0.14}Al_{0.10}Ni_{0.33}O₂.

Then, lithium carbonate was added to the recovered undersize powder so as to make a target composition Li_{1.14}Mn_{0.34}Ni_{0.30}Co_{0.13}Al_{0.09}O₂; and a lithium manganese nickel-containing oxide powder (sample) was obtained as in Example 1, except for altering the heat keeping temperature of the regular calcination 2 to 1,000° C.

As a result of a chemical analysis of the obtained lithium manganese nickel-containing oxide powder (sample), it was confirmed that the sample powder was Li_{1.14}Mn_{0.34}Ni_{0.30}Co_{0.13}Al_{0.09}O₂.

### <Measurement of the Tap Density (T.D.)>

There was determined the powder packing density (T.D.) when 50 g of the sample (powder) obtained in the Examples and the Comparative Examples each was put in a 150-ml glass measuring cylinder; and the measuring cylinder was tapped 540 times in a stroke of 60 mm on a shaking specific gravity meter (KRS-409, manufactured by Kuramochi Kagaku Kikai Seisakusho K.K.).

### <Measurement of the Crystallite Size by Rietveld Method>

A powder X-ray diffractometry of the sample (powder) obtained in the Examples and the Comparative Examples each was carried out by using an X-ray diffractometer (D8ADVANCE, manufactured by Bruker AXS K.K.) using a Cu-Kα line. At this time, the analysis was carried out by employing the fundamental parameter. The analysis was carried out on an X-ray diffraction pattern acquired in the range of diffraction angles 2θ of 15 to 120° and by using analysis software Topas Version 3.

The crystal structure was attributed to a trigonal system of a space group R3-m, and refinement to Rwp<5.0 and GOF<1.3 was carried out by assuming that its 3a site was occupied by Li; its 3b site, by Mn, Co, Ni and an excessive Li content x; and its 6c site, by 0, and by using, as variables, its oxygen seat occupancy (Occ.) and its isotropic temperature factor (Beq.).

Here, the above Rwp and GOF are values determined by the following expressions (see “Practice of Powder X-Ray Analysis” (in Japanese), edited by Discussion Group of X-Ray Analysis, The Japan Society for Analytical Chemistry, published by Asakura Publishing Co., Ltd., Feb. 10, 2002, Table 6.2 on p. 107).

Rwp=[Σᵢwi{yi−fi(x)²}/Σᵢwiyi²]^{1/2}

Re=[(N−P)/Σᵢwiyi²]^{1/2}

GOF=Rwp/Re

Here, wi denotes a statistical weight; yi, an observed intensity; fi(x), a theoretical diffraction intensity; N, a total data number; and P, the number of parameters to be refined.

The refinement procedure involved carrying out the following operations (1) to (3) in order in the state of using the z coordinate and the seat occupancy of oxygen as variables.

(1) Refinement using an isotropic temperature factor of the 3b site alone as a variable
(2) Refinement using an isotropic temperature factor of the 6c site alone as a variable
(3) Refinement using an isotropic temperature factor of the 3a site alone as a variable

The above (1) to (3) procedures were carried out repeatedly until each of the variables came not to vary. Thereafter, the z coordinate and the seat occupancy of oxygen were returned to a fixed value, and refinement was carried out repeatedly, in the state of using the crystallite size (Gauss) and the crystal strain (Gauss) as variables, until the numerical values came not to vary, and the crystallite size (Gauss) was determined.

Additionally, the instrument specification, the instrument condition and the like used in the measurement and the Rietveld method analysis are as follows.

Sample disp (mm): Refine

Detector: PSD

Detector Type: VANTEC-1

High Voltage: 5,616 V

Discr. Lower Level: 0.45 V

Discr. Window Width: 0.15 V

Grid Lower Level: 0.075 V

Grid Window Width: 0.524 V

Flood Field Correction: Disabled

Primary radius: 250 mm

Secondary radius: 250 mm

Receiving slit width: 0.1436626 mm

Divergence angle: 0.3°

Filament Length: 12 mm

Sample Length: 25 mm

Receiving Slit Length: 12 mm

Primary Sollers: 2.623°

Secondary Sollers: 2.623°

Lorentzian, 1/Cos: 0.01630098 Th

Det.1 voltage: 760.00 V

Det.1 gain: 80.000000

Det.1 discr.1 LL: 0.690000

Det.1 discr.1 WW: 1.078000

Scan Mode: Continuous Scan

Scan Type: Looked Coupled

Spinner Speed: 15 rpm

Divergence Slit: 0.300°

Start: 15.000000

Time per step: 1 s

Increment: 0.01460

#steps: 7,152

Generator voltage: 35 kV

Generator current: 40 mA

### <Calculation of the XRD Intensity Ratio>

The Kα2 and background elimination was carried out by using an X-ray diffraction pattern acquired as described above and using analysis software EVA Version 11.0.0.3. By using the X-ray diffraction pattern having undergone the elimination, a peak intensity of the main peak in the range of 2θ=20 to 22° and a peak intensity of the main peak in the range of 2θ=16 to 20° were measured, and the “XRD intensity ratio,” which is indicated in Table 2, was calculated by the following calculation expression.

Peak intensity ratio of XRD={(a main peak intensity at 2θ=20 to 22°)/(a main peak intensity in the range of 16 to 20°)}×100

### <Measurement of the Primary Particle Average Particle Diameter>

The average particle diameter of primary particles was determined as follows. The primary particles were observed by using a scanning electron microscope (HITACHI S-3500N) at an acceleration voltage of 20 kV at a magnification of 5,000 times; and 10 particles were randomly selected from their printed photograph, and minor diameters of the primary particles were measured with a ruler. The measured lengths were converted on the reduced scale, and the average value thereof was determined as the primary particle average particle diameter, which was indicated as “primary particle diameter” in Table 2.

### <Measurement of the 50% Cumulative Diameter (D50)>

The particle size distribution of the sample (powder) obtained in the Examples and the Comparative Examples each was measured as follows.

A sample recirculator (“Microtrac ASVR,” manufactured by Nikkiso Co., Ltd.) for a laser diffraction particle size distribution analyzer was used; the sample (powder) was charged in a water-soluble solvent; the mixture was irradiated with a 40-W ultrasonic wave for 360 sec in a flow rate of 40 mL/sec; thereafter, the particle size distribution was measured using the laser diffraction particle size distribution analyzer “HRA (X100),” manufactured by Nikkiso Co., Ltd.; and D50 was determined from a chart of an obtained particle size distribution in terms of volume.

Here, as the water-soluble solvent in the measurement, water having been passed through a 60-μm filter was used; and with the conditions that: the solvent refractive index is 1.33; the particle transparency condition is reflection; the measurement range is 0.122 to 704.0 μm; and the measuring time is 30 sec, an average value of two-times measurements was used as a measurement value.

### <Measurement (BET Method) of the Specific Surface Area (SSA)>

The specific surface areas (SSAs) of the sample (powder) obtained in the Examples and the Comparative Examples each was measured as follows.

First, 0.5 g of the sample (powder) was weighed in a glass cell for a flow-type gas adsorption-measuring specific surface area analyzer MONOSORB LOOP (“MS-18,” manufactured by Yuasa Ionics), and the glass cell interior was replaced by nitrogen gas at a gas volume of 30 mL/min for 5 min by using a pre-treatment apparatus for the MONOSORB LOOP. Next was subjected to a heat treatment in the nitrogen gas atmosphere at 250° C. for 10 min.

Thereafter, the sample (powder) was measured by one point method for BET by using the MONOSORB LOOP.

Here, as an adsorption gas in the measurement, a mixed gas of 30% of nitrogen and 70% of helium was used.

### <Fabrication Method of Electrodes>

89% by weight of each of the lithium manganese nickel-containing oxide powders (samples) obtained in the Examples and the Comparative Examples, 5% by weight of an acetylene black as a conduction supporting agent, and 6% by weight of a PVDF as a binder were mixed, and made into a paste by adding NMP (N-methylpyrrolidone). The paste was applied on an Al foil current collector of 15 μm in thickness, and dried at 70° C. and 120° C. Thereafter, the resultant was three times pressed at a pressure of 20 MPa to thereby fabricate a positive electrode sheet.

### <Evaluation Method of the Electrode Density>

A positive electrode sheet volume was determined by multiplying an area of the positive electrode sheet obtained in the above by a thickness of the positive electrode sheet as measured using a micrometer (MITUTOYO MDC-30). Then, the weight of a positive electrode itself was determined by subtracting a weight of the Al foil from a weight of the positive electrode sheet. The electrode density was determined by dividing the weight of the positive electrode sheet by the positive electrode sheet volume.

Here, in Table 2, the electrode density was indicated as a relative value (index) with the electrode density of Comparative Example 1 being taken to be 100.

### <Fabrication Method of Cells for Evaluation>

The positive electrode sheet obtained in the above was cut out into a size of φ13 mm to thereby make a positive electrode, which was then dried at 200° C. for 6 hours. On the other hand, lithium metal was cut out into a size of φ15 mm to thereby make a negative electrode; and a separator (porous polyethylene film) impregnated with an electrolyte solution in which LiPF₆ was dissolved in 1 mol/L in a carbonate-based mixed solution was placed between the positive electrode and the negative electrode to thereby fabricate a 2032-type coin cell (cell for electrochemical evaluation).

### (Charge and Discharge Efficiency in One Cycle)

By using the 2032-type coin cell prepared as described above, charge and discharge capacities and a charge and discharge efficiency in one cycle were determined by the following method. That is, a charge capacity (mAh/g) of an active substance was determined from a capacity when the cell was charged at 25° C. at a current value of 0.2 C up to 4.9 V and from a content of the positive electrode active material in the positive electrode. A pausing time of 10 min was taken, and then, an initial discharge capacity (mAh/g) of the active substance was determined from a capacity when the cell was discharged at a current value of 0.2 C down to 2.0 V. The ratio of the discharge capacity to the charge capacity was determined as a charge and discharge efficiency (%) in one cycle.

### (Charge and Discharge Capacities in One Cycle)

By using the 2032-type coin cell prepared as described above, charge and discharge capacities and a charge and discharge efficiency in one cycle were determined by the following method. That is, a total charge capacity (mAh/g) of an active substance was determined from a capacity when the cell was charged at 25° C., constant current value of 0.2 C up to 4.9 V (CC charge), and after the cell reached a voltage of 4.9 V, was charged at the constant voltage value (CV charge) and from a content of the positive electrode active material in the positive electrode. A pausing time of 10 min was taken, and then, an initial discharge capacity (mAh/g) of the active substance was determined from a capacity when the cell was discharged at a constant current value of 0.2 C down to 2.0 V.

### (Evaluation of the Rate Capability)

By using the 2032-type coin cell (cell for electrochemical evaluation) after being evaluated for the initial charge and discharge efficiency as described above, a charge and discharge test was carried out using the following method, and the rate capability was evaluated.

The cell was put in an environmental test chamber whose environmental temperature for charge and discharge for the cell was set at 25° C., and prepared so as to be able to be charged and discharged; with the charge and discharge range being set at 2.0 V to 4.6 V, charging was carried out at a current value of 0.2 C and then discharging was carried out at a current value of 2 C. After the discharging, dischargings at 1.0 C, 0.5 C, 0.2 C and 0.1 C were further carried out in order. A 10-min pausing was taken each time between the dischargings. The combination of the charging and the dischargings at the respective rates was repeated in three cycles. The ratio of a third-cycle discharge capacity at 2.0 C to a total of third-cycle discharge capacities of the respective rates was determined as a rate capability as in the following expression; and in Table 2, the ratio was indicated as a “2.0 C/0.1 C capacity ratio.”

Rate capability=(a third-cycle discharge capacity at 2.0 C)/(a total of third-cycle discharge capacities of the respective discharge rates))×100

### (Volumetric Energy Density Index)

A volumetric energy density was calculated by multiplying the initial discharge capacity by the electrode density, which were both determined as described above; and in Table 3, the volumetric energy density was indicated as a relative value (index) in the case where the volumetric energy density of Comparative Example 1 was taken to be 100. A higher volumetric energy density is preferable.

(Volumetric energy density index)=(an initial discharge capacity)×(an electrode density)

### (Evaluation of the Charge Rate Capability)

The charge rate capability index, that is, an index of charge acceptability, was calculated from the charge capacity measured as described above, and was indicated in Table 3. When the charge rate capability index thus calculated is low, the rate capability in the charge time, that is, the charge acceptability can be evaluated as good. By using this index, it can be presumed that the rate capability of a positive electrode active material is good.

Charge rate capability index=(a capacity in the CV charging)/(a total charge capacity)×100

TABLE 1

| | | Mn Content in |
|---|---|---|
| | Composition from | Ma |
| | Analyzed Value | wt % |
| Comparative | Li_{1.17}Mn_{0.56}Ni_{0.27}O₂ | 66 |
| Example 1 | | |
| Comparative | Li_{1.21}Mn_{0.40}Ni_{0.39}O₂ | 49 |
| Example 2 | | |
| Example 1 | Li_{1.13}Mn_{0.45}Ni_{0.42}O₂ | 50 |
| Example 2 | Li_{1.16}Mn_{0.50}Ni_{0.34}O₂ | 58 |
| Example 3 | Li_{1.14}Mn_{0.34}Ni_{0.30}CO_{0.13}Al_{0.09}O₂ | 40 |

TABLE 2

| | | | | | | | Electrode | | | |
|---|---|---|---|---|---|---|---|---|---|---|
| | | | | | | | Density | | | |
| | | | | | | | Index (the | | | |
| | | | | | | | case where | | | |
| | Primary | | | XRD | | | Comparative | Initial | Charge and | 2.0 c/0.1 c |
| | Particle | | Crystallite | Intensity | | | Example 1 | Discharge | Discharge | Capacity |
| | Diameter | D50 | Size | Ratio | T.D. | SSA | was taken | Capacity | Efficiency | Ratio |
| | (um) | (um) | (nm) | % | (g/cm³) | (m²/g) | to be 100) | (mAh/g) | (%) | (%) |
| Comparative | 0.6 | 17 | 82.1 | 4.7 | 1.4 | 1.0 | 100 | 207 | 69 | 76 |
| Example 1 | | | | | | | | | | |
| Comparative | 0.8 | 7 | 73.4 | 1.6 | 1.8 | 1.9 | 95 | 189 | 57 | 76 |
| Example 1 | | | | | | | | | | |
| Example 1 | 1.2 | 10 | 67.2 | 1.1 | 2.2 | 1.4 | 110 | 239 | 77 | 80 |

TABLE 3

| | | | | | | | | | Volumetric | |
|---|---|---|---|---|---|---|---|---|---|---|
| | | | | | | | | | Energy | |
| | | | | | | | Electrode | | Density | |
| | | | | | | | Density | | Index | |
| | | | | | | | Index (the | | Index (the | |
| | | | | | | | case where | | case where | Charge |
| | Primary | | | XRD | | | Comparative | Initial | Comparative | Rate |
| | Particle | | Crystallite | Intensity | | | Example 1 | Discharge | Example 1 | capability |
| | Diameter | D50 | Size | Ratio | T.D. | SSA | was taken to | Capacity | was taken to | Index |
| | (um) | (um) | (nm) | (%) | (g/cc) | (m²/g) | be 100) | (mAh/g) | be 100) | (%) |
| Comparative | 8.6 | 17 | 82.1 | 4.7 | 1.4 | 1.0 | 100 | 287 | 100 | 16 |
| Example 1 | | | | | | | | | | |
| Comparative | 0.8 | 7 | 73.4 | 1.6 | 1.8 | 1.9 | 95 | 100 | 83 | 10 |
| Example 2 | | | | | | | | | | |
| Example 1 | 1.2 | 10 | 67.2 | 1.1 | 2.2 | 1.4 | 110 | 239 | 127 | 3 |
| Example 2 | 2.0 | 10 | 83.0 | 2.5 | 1.9 | 1.4 | 102 | 285 | 101 | 10 |
| Example 3 | 1.9 | 8 | 148.2 | 0.9 | 2.1 | 0.7 | 137 | 194 | 102 | 10 |

### (Consideration)

It was found that the samples obtained in Examples 1 to 3 could have a higher volumetric energy density as their electrodes than the samples of Comparative Examples 1 and 2, and moreover because of exhibiting charge acceptability equal to or higher than that of the samples thereof in spite of being improved in the electrode density, had a good rate capability, especially a good charge rate capability.

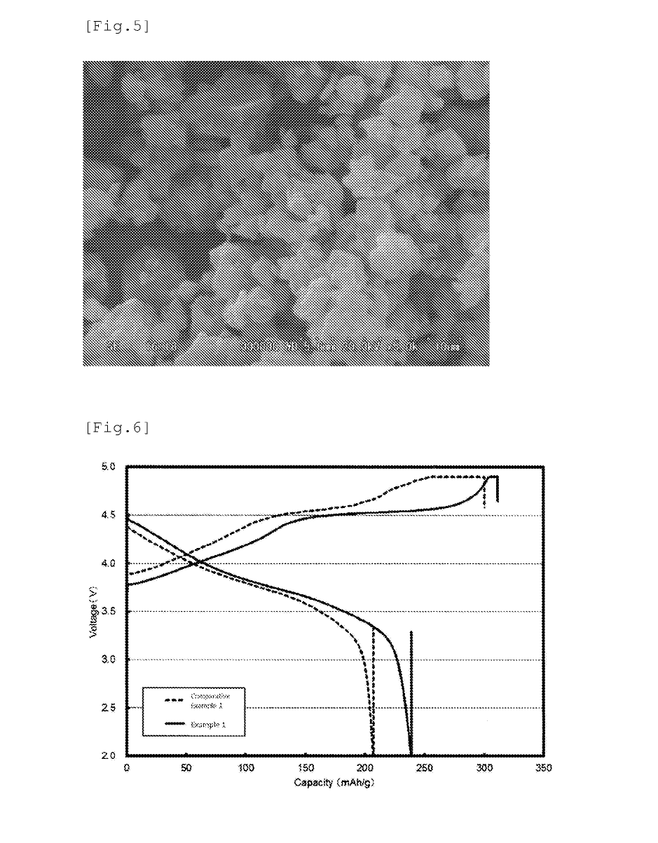

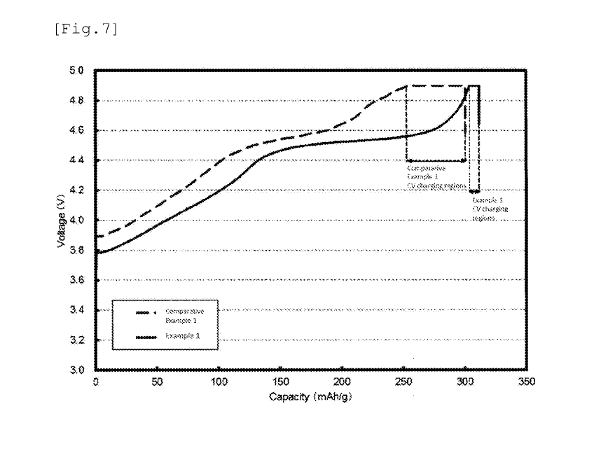

Further as seen in FIG. 5, it was found that Examples 1 to 3 were better in charge acceptability and better in the rate capability than the Comparative Examples, also from differences between lengths of their CV charging regions.

Here, although Example 3 comprised a composition containing Al alone as Mb in the general formula Li₁₊ₓMa_{1-x-y}Mb_{y}O₂, since Al has properties common with Mg, Ti, Fe and Nb in the points of the ionic radius and the chemical stability, it can also be considered in the case where Mb contains at least one or more elements selected from the group consisting of Al, Mg, Ti, Fe and Nb that the case can have an effect similar to that of the sample obtained in Example 3.

From the Examples and the results of the tests carried out by the inventors, when the primary particle average particle diameter was 1.0 μm or larger, and the tap density was 1.9 g/cm³ or higher, since the volumetric energy density as an electrode could be raised and moreover, the charge acceptability was equal or higher in spite of the improved electrode density, it can be considered that the Examples exhibited a good rate capability, especially a good charge rate capability.

1. A positive electrode material for a lithium-ion cell, comprising a lithium metal composite oxide having a layer structure and being represented by the general formula Li₁₊ₓMa_{1-x-y}Mb_{y}O₂ (x=0.10 to 0.33, and y=0 to 0.3; and a Mn content in Ma is 30 to 80% by mass; and Mb is at least one or more elements selected from the group consisting of Al, Mg, Ti, Fe and Nb), wherein the positive electrode material has a primary particle average particle diameter of 1.0 μm or larger, and a tap density of 1.9 g/cm³ or higher.

2. The positive electrode material for a lithium-ion cell according to claim 1, wherein a crystallite size is 50 nm or larger.

3. The positive electrode material for a lithium-ion cell according to claim 1, wherein in a diffraction pattern of an X-ray diffraction (XRD), an intensity of a main peak in the range of 2θ=20 to 22° in regard to a main peak in the range of 2θ=16 to 20° is lower than 4.0%.

4. A lithium-ion cell comprising, as a positive electrode active material thereof, a positive electrode active material for a lithium-ion cell according to claim 1.

5. A lithium-ion cell for a hybrid electric vehicle or an electric vehicle, comprising, as a positive electrode active material thereof, a positive electrode active material for a lithium-ion cell according to claim 1.

6. The positive electrode material for a lithium-ion cell according to claim 2, wherein in a diffraction pattern of an X-ray diffraction (XRD), an intensity of a main peak in the range of 2θ=20 to 22° in regard to a main peak in the range of 2θ=16 to 20° is lower than 4.0%.

7. A lithium-ion cell comprising, as a positive electrode active material thereof, a positive electrode active material for a lithium-ion cell according to claim 2.

8. A lithium-ion cell comprising, as a positive electrode active material thereof, a positive electrode active material for a lithium-ion cell according to claim 3.

9. A lithium-ion cell for a hybrid electric vehicle or an electric vehicle, comprising, as a positive electrode active material thereof, a positive electrode active material for a lithium-ion cell according to claim 2.

10. A lithium-ion cell for a hybrid electric vehicle or an electric vehicle, comprising, as a positive electrode active material thereof, a positive electrode active material for a lithium-ion cell according to claim 3.
